(19) United States
(12) Patent Application Publication
(10) Pub. No.: US 2006/0110573 A1
(43) Pub. Date: May 25, 2006

(54) Paperboard padding

(76) Inventors: Cheng-Szu Peng, Sanxia City (TW); Cheng-Chung Chang, Xizhi City (TW)

Correspondence Address: East Sun Paper Company Limited &;Sercomm Corporation, P.O. Box No. 6-57, Junghe, TAIPEI 235, TW

(21) Appl. No.: 10/991,412

(22) Filed: Nov. 19, 2004

(51) Int. Cl. B32B 3/04

(52) U.S. Cl. 428/121

(57) ABSTRACT

The invention discloses a paperboard padding made from a piece of paperboard, and has following characteristics: both of two narrow edges and long edges of the paperboard has one folding part and wrap part to form a container base. The four connection areas of the reverse folding part and wrap part has a protection card, and at the connection edge of reverse folding part and container has an open groove; Both end of the wrap part cut into a slit respectively with a flap in the center, then at the connection corner of reverse folding part, wrap part, and protection card sets a hole from which spans four folding parts; At both sides of the container base next to folding part sets a fixed plate which has convex plate corner extended to the inner side.

### BACKGROUND OF THE INVENTION

(a) Field of the Invention

The present invention relates to paperboard padding, more particularly, to a compact product with safe and commercial effect for decreasing the size of paperboard padding, convenience of delivery, rapid package procedures, and attaining sufficient protection in all purpose.

(b) Description of the Prior Art

Conventionally, packaging material could protect goods from damage during transportation; efficient package can safeguard goods from collision and shaking. Traditional package material used materials made from foam, polystyrene, bubble clothes, etc., and enforced corner and fragile portion by stuffing materials to fill the gap so as to isolate and hold goods firmly, and absorb shocking force from collision to avoid damage from shaking. The packaging of fragile electronic appliance, such as video cassette recorder, micro wave, TV, computer monitor, telephone, etc needs stuffing material to fill the gap so that the shocking force can dispense evenly to the goods packaged and therefore to reduce the damage. Stuffing material such as foam, polystyrene, bubble clothes, etc. are made from plastic raw material and hard to decay, and therefore cause environment pollution. Usage of paper-made material replacing with plastic-made material can reduce environment pollution. Therefore, because of no harm to environment characteristics the paperboard becomes popular in packaging materials and play an important role in packaging techniques.

The structure of paperboard is not as simple as those materials of foam, polystyrene, bubble clothes, etc., it is needed to fold and combine into a shape so as to hold goods, please refer to FIG. 4. Traditional paperboard cushion material used for packaging the electronic appliance was folded by multiple paperboard and bent into various kind of shapes, then cut several connected holes on the surface of the paperboard, and combine these paperboards to form a holding container. The container is suitable for the length and width of a specific goods, while the outside dimension of the paperboard cushion designed to fit the carton size, then put the paper cushion on both end of the goods before packaging into a carton to finish a packaging processing. Traditional paperboard cushion provides the shock absorbing structure to protect the packaged goods from damage by collision, but this absorbing structure is difficult to design, and cost consuming and less competitive.

Moreover, due to the conventional function of paperboard to provide shock absorbing structure, the size could not be too compact to decrease the bumper structure length. The smaller the paperboard size, the shorter the shock absorbing length which will very easily cause damage to the goods by a small collision. Although large size paperboard has stronger shock absorbing length, the space occupation defect of finish products decreases the delivery quantity between packaging and manufacturing factory. Not only increase transporting cost, but also increase warehousing space which brings management bothers.

### SUMMARY OF THE INVENTION

It is therefore a primary object of the present invention to provide paperboard padding with features of compact size for convenient transportation, rapid packaging, and sufficient protection of packaged goods.

The paperboard padding made of a piece of paperboard, and has following characteristics: Both of two narrow edges and long edges of the paperboard has one folding part and wrap part to form a container base. The four connection areas of the reverse folding part and wrap part has a protection card, and at the connection edge of folding part and container has an open groove; At both end of the wrap part cut into a slit respectively and one flap at the center, then at the connection corner of reverse folding part, wrap part, and protection card sets a hole from which spans four folding parts; At both sides of the container base next to folding part sets a fixed plate which has convex plate corner extended to the inner side.

Because of the connection between reverse folding part concaving down to container base, and protection card to form a bumper shock absorbing structure at the bottom and both ends of the goods. Furthermore, the wrap part cover around the top and both side of the goods to form an elastic and absorbing structure, spare the shocking from the top of goods to both sides of the wrap, and absorbing by the container base and protection card to safeguard the goods in whole.

### BRIEF DESCRIPTION OF THE DRAWINGS

The structure and the technical means adopted by the present invention to achieve the above and other objects can be best understood by referring to the following detailed description of the preferred embodiments and the accompanying drawings, in which:

FIG. 1 is a schematic drawing of the present invention before being folded;

FIG. 2 is a perspective view of the present invention after being folded;

FIG. 3 is an embodiment of the present invention;

FIG. 4 is a schematic drawing of an embodiment of a prior art.

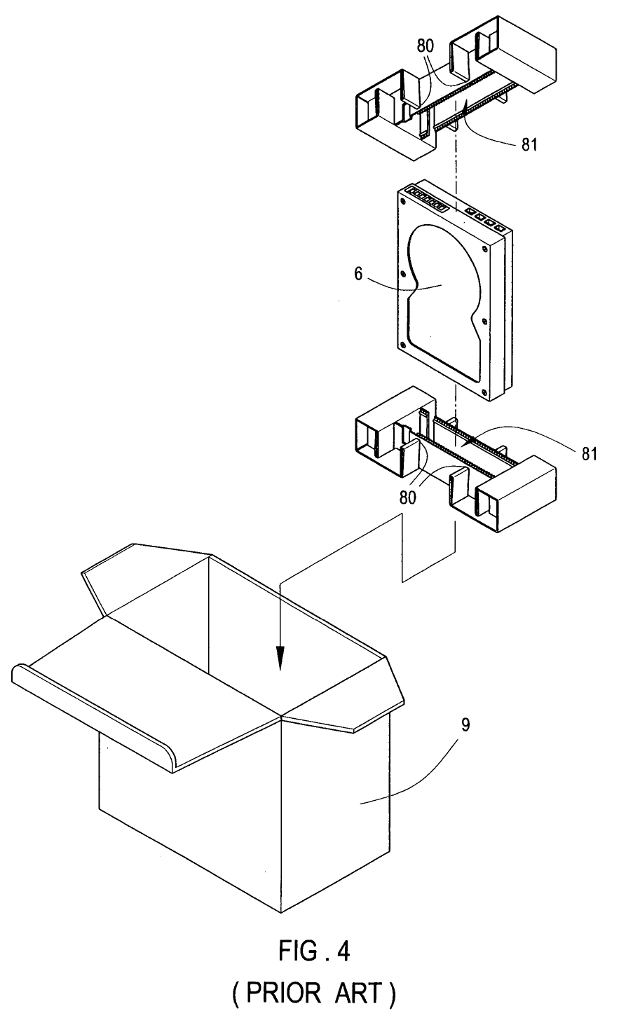

### DETAILED DESCRIPTION OF THE PREFERRED EMBODIMENT

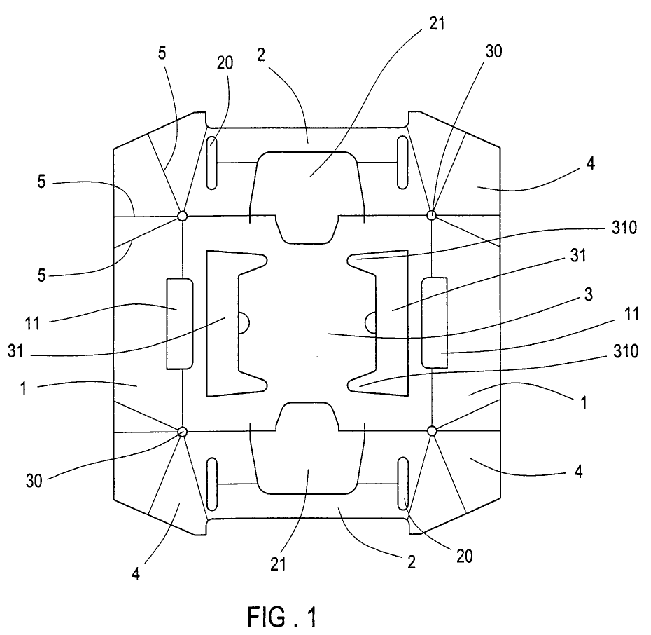

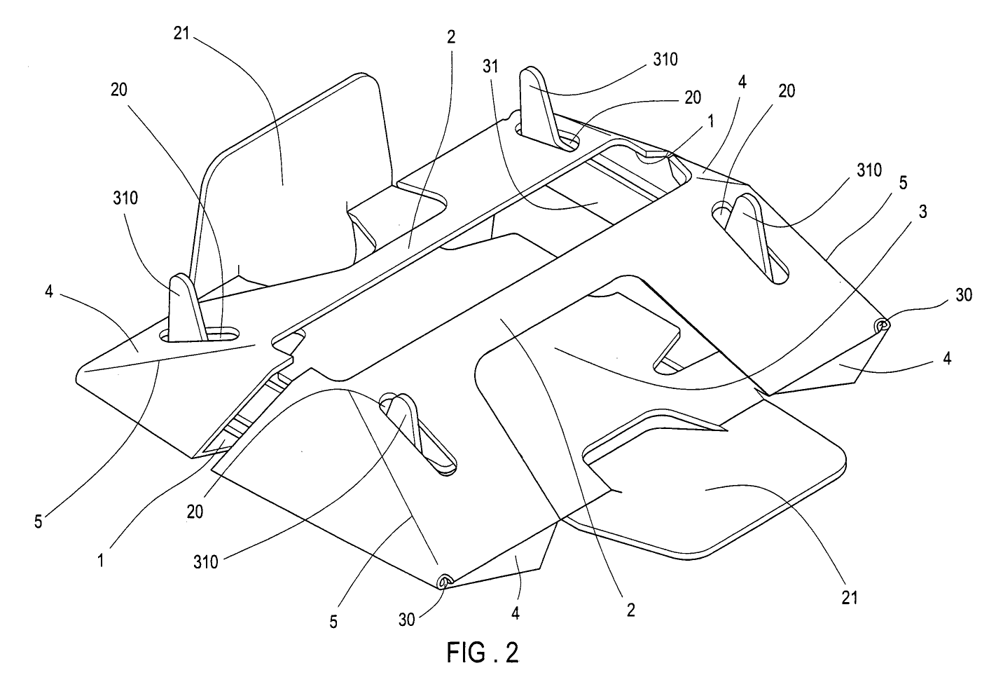

Refer to FIG. 1 and FIG. 2, the paperboard padding made of a piece of paperboard in accordance with the present invention has following characteristics:

Both of two narrow edges and long edges of the paperboard has one folding part and wrap part 2 to form a container base 3.

The four connection areas of the reverse folding part 1 and wrap part 2 has a protection card 4, and at the connection edge of folding part 1 and container 2 has an open groove 11;

At both end of the wrap part 2 cut into a slit 20 respectively and one flap 21 at the center, then at the connection corner of reverse folding part 1, wrap part 2, and protection card 4 sets a hole 30 from which spans four folding parts 5;

At both sides of the container base 3 next to folding part 1 sets a fixed plate 31 which has convex plate corner 310 extended to the inner side.

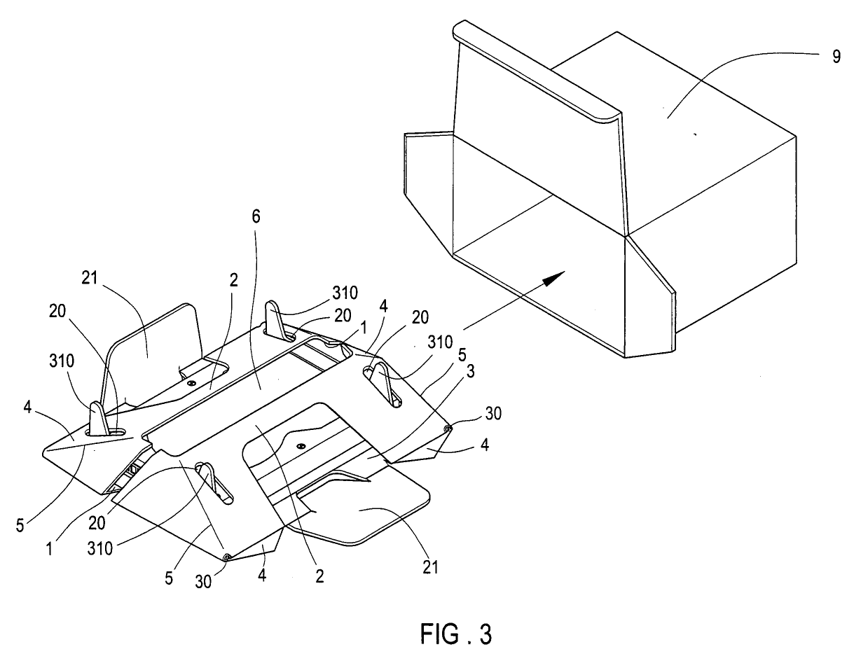

Further refer to FIG. 3, when producing the present invention, bent up fixed plate 31 perpendicular to the surface, then put goods 6 to be packaged into container base 3, and bent down reverse folding part 1 along with folding part 5 into container base 3. The protection card 4 of both end stretched when bending down reverse folding part 1, then connect with upper inner side of reverse folding part 1 according to folding part 5, and insert reverse folding part 1 together with protection card 4 into the bottom of container base 3, so that protection card 4 position at the lowest part, reverse folding part 1 upper the protection card 4, container base 3 at upper side of reverse folding part 1. the hole 30 provides reverse folding part 1 and protection card 4 a folding space to safeguard the paperboard from broken when bending into container base 3. The wrap part 2 which is stretched and lifted simultaneous from both sides of container base 3, when protection card 4 bending into the inncer upper side of reverse folding part 1. The wrap part 2 lifted till perpendicular to container base 3, therefore makes the wrap part 2 and flap 21 cover on the container base 3 from both sides to central to shape a container base 3 holding goods 6, the convex plate corner 310 at both ends of the fixed plate 31 pick through slit 20, and make use of the wrap part 2 and fixed plate 31 to hold goods firmly into the container base 3 without the risk of sliding from either side of reverse folding part 1, then package goods 6 with this invention into the carton 9.

The combination of flap 21 and groove 11 enforce the structure strength of wrap part 2 and reverse folding part 1, the groove 11 makes reverse folding part 1 bent into the bottom surface of container base 3 more easily.

As mentioned above, the folding part between reverse folding part and protection card form a bumper distance. Because of the connection between reverse folding part concaving down to container base, and protection card to form a bumper shock absorbing structure at the bottom and both ends of the goods. Furthermore, the wrap part cover around the top and both side of the goods to form an elastic and absorbing structure, spare the shocking from the top of goods to both sides of the wrap, and absorbing by the container base and protection card to safeguard the goods in whole.

Furthermore, before finish the present invention, the raw material of the present invention is a well-designed cut of a paperboard, and could be piled and stacked together for delivery and warehousing other than traditional device of paperboard padding which needs to fold and bent into a solid shape and glue together. The device only casts once into a pre-designed shape, and decrease the manufacturing cost.

While a preferred embodiment of the invention has been shown and described in detail, it will be readily understood and appreciated that numerous omissions, changes and additions may be made without departing from the spirit and scope of the invention.

What is claimed is:

1. A paperboard padding made of a piece of paperboard is characterized in that:
one reverse folding part and one wrap part are arranged on each of two narrow edges and long edges of the paperboard while a container base is formed therebetween;
a protection card is disposed on the four connection areas of the reverse folding part and the wrap part while an open groove is located at the connection edge of the folding part and the container base;
at both end of the wrap part cut into a slit respectively with one flap at the center of the wrap part; a hole is set at the connection corner of the reverse folding part, the wrap part, and the protection card from which spans four folding parts;
a fixed plate having a convex plate corner extending to inner side thereof is disposed at both sides of the container base next to the folding part.
